(19) United States
(12) Patent Application Publication
(10) Pub. No.: US 2012/0210586 A1
(43) Pub. Date: Aug. 23, 2012

(54) HAIR CUTTING DEVICE WITH PIVOTING MECHANISM

(75) Inventors: Mark Johannes Lelieveld, Drachten (NL); Jasper Zuidervaart, Drachten (NL); Johan Pragt, Drachten (NL)

(73) Assignee: KONINKLIJKE PHILIPS ELECTRONICS N.V., EINDHOVEN (NL)

(21) Appl. No.: 13/501,930

(22) PCT Filed: Nov. 5, 2010
(86) PCT No.: PCT/IB2010/055030

§ 371 Date: Apr. 13, 2012

(30) Foreign Application Priority Data
Nov. 12, 2009 (EP) 09175748.4

(51) Int. Cl. B26B 21/52; B26B 21/40

(52) U.S. Cl. 30/527

(57) ABSTRACT

Hair cutting device comprising a base portion (20), a working head (21) and at least one pivoting mechanism (10) provided in between the base portion and the working head for a pivoting movement of the working head with respect to the base portion. The pivoting mechanism comprises a contact body (11) having a contact surface (14), wherein said contact body is connected to the base portion, and a counter body (13) having a running surface (14) interacting with the roller surface, wherein said counter body is fixedly connected to the working head. Further, the pivoting mechanism comprises a holding unit (15) for connecting the contact body to the counter body.

### FIELD OF THE INVENTION

The present invention relates to a hair cutting device. Such a hair cutting device is for example a razor, in particular a blade shaver or an electrical shaving device.

### BACKGROUND OF THE INVENTION

US 2005198843 discloses a razor including a linkage mechanism. The linkage mechanism has been configured for a razor having a head carrying at least one razor blade mounted for a large extent of rocking about a virtual pivot axis. The virtual pivot axis remains nearly static during pivoting. The linkage mechanism is attached to a handle and has five links, which include a pair of spaced support arms pivoted to the head at first and second pivot axes. The first and second pivot axes being spaced apart by a first distance. A first transverse link member is pivoted on the body for rotation about a third axis and pivoted on each of the support arms, a fourth and fifth pivot axes are spaced apart by a second distance less than the first distance, and second and third transverse link members are pivoted on the handle at respective first ends thereof and pivoted on respective second ends thereof to respective first ends thereof and pivoted on respective second ends thereof to respective ones of the support arms at sixth and seventh pivot axes spaced apart by a third distance. The first, second, third, fourth, fifth, sixth and seventh axes are mutually parallel.

One drawback of the referred razor is that it has a complex assembly. The complex assembly is vulnerable to damages during use. The mechanism has a lot of pivoting components which may fail due to contamination or wear. Due to the amount of components, the assembly is relatively difficult to manufacture, which leads to undesired high costs.

### SUMMARY OF THE INVENTION

It would be desirable to at least partially eliminate the above drawbacks and/or to provide a usable alternative. It would also be desirable to provide a hair cutting device having a pivoting mechanism which provides a virtual pivoting axis near or at a user's skin level.

The hair cutting device according to the invention comprises a base portion, a working head and at least one pivoting mechanism. In particular, the hair cutting device is a shaving device. The base portion is configured to be gripped by a user and may include a grip for holding the device by hand. The working head is configured to hold at least one cutter and may e.g. be a razor blade cartridge. The pivoting mechanism is configured to pivotally connect the base portion to the working head and is configured to provide an outer virtual pivot axis.

In particular, the pivoting mechanism may also be called a link mechanism or more in particular a rolling link mechanism. The pivoting mechanism comprises a contact body, a counter body and a holding unit. The contact body is connected to the base portion. The counter body is connected to the working head. The contact body has an outer contact surface. The counter body has an outer running surface. The holding unit guides the contact body over a stroke along the running surface of the counter body. The holding unit is configured to hold the contact surface of the contact body such that, during use, the contact body runs along the running surface of the counter body. The holding unit couples the contact body to the counter body. The contact body may roll or slide along the running surface. The contact surface of the contact body may be directly in contact with the running surface of the counter body. The holding unit is spring-loaded for returning the contact body to an initial position along the running surface. The holding unit comprises at least one elongated connecting component which extends at least partially tangentially along the running surface. At least one end of the connecting component may be fixed to the running surface. By virtue thereof, a compact configuration of the pivoting mechanism may be obtained. During operation, the pivoting mechanism may provide low friction forces which may keep the pivoting mechanism substantially free of hysteresis. Advantageously, the spring load may provide a torque to the pivoting mechanism which may be necessary for the working process corresponding with the hair cutting device, e.g. a shaving process.

Advantageously, the pivoting mechanism provides an outer virtual pivot point, which position may be defined by the running surface of the counter body. Advantageously, the virtual pivot point is positioned external to the pivoting mechanism. For skin care hair cutting devices it may be desired to position a pivot point near or at skin level at a lower region of the working head. To obtain such an arrangement, preferably, the running surface of the counter body which is positioned at an upper region of the working head is convex. By virtue thereof, the virtual pivot point may be positioned below the counter body in a center of the convex running surface. Advantageously, the handheld device according to the invention comprises a pivoting mechanism which may provide a position of the virtual pivot point even outside the working head e.g. at skin level or at least close to skin level, i.e. just above or just below a skin surface. Improved skin contour following properties may be achieved when a working head, e.g. a razor blade cartridge, is connected by the pivoting mechanism according to the invention to the base portion. Additionally, the hair cutting device according to the invention may be less susceptible to wear or damage. Components of the pivoting mechanism advantageously may have a relatively robust configuration.

In an embodiment of the hair cutting device according to the invention the contact body has a cylindrical contact surface including a constant radius and the counter body has a convex running surface also including a constant radius. This may result in a static position of the virtual pivot point in the center of the running surface. During shaving, when the working head contacts the skin, the base portion may make a pivoting movement with respect to the working head. Advantageously, due to the presence of the pivoting mechanism according to the invention, the risk of an unexpected angular translation of the working head with respect to the skin during the pivoting movement may be decreased. Thus, the risk of injuries may be decreased.

In an embodiment of the haircutting device according to the invention, the contact body is a roller including an outer roller surface. The roller is connected to the base portion. In particular, the roller is rotatably connected to the base portion. The roller may have an inner axis of rotation. The counter body has a running surface interacting with the roller surface. The counter body is connected to the working head. In use, the roller may roll and run over the running surface of the counter body. In particular, the roller rolls substantially slip-free along the running surface. Advantageously, the pivoting mechanism including the roller may operate very lightly. The roller may travel over a stroke along the running surface from a start position to an end position. In use, the axis of rotation of the roller may be displaced relative to the counter body. The holding unit connects the roller to the counter body and guides the roller during the displacement over the running surface. The holding unit connects the roller in a radial direction to the counter body.

In an embodiment of the hair cutting device according to the invention, the running surface of the counter body has various radii. The running surface may be subdivided into running surface sections. Each subsequent running surface section may have another radius or another arbitrary contour. A running surface section may have an infinite radius, which may make the running surface section flat. Preferably, the running surface of the counter body has a convex contour. Advantageously, a running surface comprising at least two different running surface sections may define a virtual pivot path. During a rolling movement of the roller over the running surface, the virtual pivot point may move over the virtual pivot path. The pivot point may e.g. translate along a straight line during the pivoting movement. By virtue thereof, advantageously, the running surface may be adapted optimally to requirements of a working process corresponding to the hair cutting device. In particular for a shaving device it may be desired to include a virtual pivot path to obtain improved skin contour properties in a neck zone.

In an embodiment of the hair cutting device according to the invention, at least one of the running surface and the roller surface comprises a groove which extends in a length direction. Advantageously, the groove may collect any contamination which could disturb the proper running of the contact body. Advantageously, one of the running or roller surface is provided with a complementary organ which may fit into the groove. By virtue thereof, the roller may be guided along the running surface. Advantageously, the roller may remain in a transversal position with respect the counter body. Transversal forces acting on the pivoting mechanism may be overcome by enclosing the complementary organs in the groove.

In an embodiment of the hair cutting device according to the invention, the holding unit is a linking bar. The linking bar may be longitudinal having a first and a second end. The first end may be fixed to the contact body, and the second end may be fixed to the counter body. Advantageously, the linking bar guides the contact body along the running surface.

In an embodiment of the hair cutting device according to the invention, the holding unit may e.g. be a wire or a thin strip. The holding unit may be a metal strip. The holding unit may be elongated having a first and a second end. The first end of the holding unit may be fixed to a first position on the running surface and the second end of the holding unit may be fixed to a second position on the running surface. The contact body may be movable in between the first and the second position on the running surface. The holding unit may be flexible in that during use the holding unit may be elastically deformed due to occurring forces. The holding unit may e.g. be flexible in that the holding unit bends during a movement of the roller. Advantageously, the flexible holding unit may keep the roller in contact with the running surface, e.g. by exerting a pressing force.

In a further embodiment of the hair cutting device according to the invention, the holding unit may have a fixation point at an intermediate partition to fix the holding unit to the contact body, in particular the roller. In particular, the holding unit extends along the running surface, wherein the intermediate partition is wound at least partially along the roller surface. The holding unit may be subdivided by the fixation point into a first and a second section. When the roller runs over the running surface, the first section of the holding unit unwinds while the second section winds up to the roller. Advantageously, the fixing of the intermediate partition to the roller may prevent slip of the roller with respect to the running surface. Since the roller is fixed at both sides by the holding unit, slip may be prevented in both directions along the running surface. Advantageously, the roller may be locked to the running surface of the counter body and only a pure rolling movement may be allowed.

In a further embodiment of the hair cutting device according to the invention, the first and the second section of the holding unit may be formed by a first and a second connecting component. Instead of a one-piece holding unit, the holding unit may comprise at least two connecting components. The connecting component may be a wire or a strip. The holding unit may e.g. comprise a pair of wires. The pair of wires may include a first and a second wire. The wires may be fixed at one end to the running surface and at an opposite end to the roller surface. Preferably, from the fixation point on the roller, the second wire may be arranged as a prolongation of the first wire. The first and the second wire may be wound crosswise along the roller surface, such that always one of the wires unwinds during a movement of the roller. Advantageously, the connecting component provides a simple configuration to keep the roller on the running surface and to prevent slip of the roller.

In an embodiment of the hair cutting device according to the invention, the holding unit and the contact body are formed in one piece with each other. The holding unit may be incorporated into the contact body. The holding unit may e.g. be defined by two wires which may be moulded together with the contact body. The assembly of the holding unit and the roller may advantageously be relatively simply manufactured by injection moulding.

In an embodiment of the hair cutting device according to the invention, the pivoting mechanism is spring-loaded. An additional spring member may be provided to return the contact body to an initial position. Advantageously, the spring load may provide a torque which may be necessary for the working process corresponding with the hair cutting device, e.g. a shaving process. Preferably, the spring member is a leaf spring. Advantageously, the leaf spring may impose a mechanical torque on the pivot axis to keep the blade cartridge in position so as to obtain an appropriate contour-following action.

In an advantageous embodiment according to the invention, the spring member may be integrated in the holding unit. By virtue thereof, the holding unit may be resilient. The holding unit may comprise the leaf spring. The leaf spring may be fixed at one end to the running surface and at the other end to the roller surface. During use, a part of the leaf spring may be disposed along the running surface, wherein a remaining part may be wound along the roller surface. As a result, the leaf spring prevents the roller from slipping, in one direction, away from the spring leaf in a length direction along the running surface, and at the same time produces a spring load to return the roller to its initial position. Thus, advantageously, a pretension is incorporated in the holding unit.

In an embodiment of the hair cutting device according to the invention, the spring leaf has a decreasing cross section in a length direction. The spring leaf may be inclined, e.g. conical. Advantageously, the spring leaf includes a constant spring energy when the spring leaf is unwound. During the pivoting movement, the spring leaf may generate a substantially constant force, which may force the contact body back to the initial position.

In an embodiment of the hair cutting device according to the invention, the hair cutting device comprises an assembly of at least three pivoting mechanisms. A first pivoting mechanism may have a first counter body and a first contact body. A second pivoting mechanism may have a second counter body and a second contact body. The first and the second contact body may be rotatably connected to the base portion. The base portion may comprise a grip; the base portion may e.g. be configured as a handle. The handle may be fork-shaped, wherein the first and the second contact body may be connected to the distal end of the handle. The first and the second contact body may be aligned for defining a first pivot axis. The first and the second pivoting mechanism leave two degrees of freedom for moving the base portion with respect to the working head. A first degree of freedom is determined by the first and the second aligned running surfaces. The base portion may translate along the working head. The second degree of freedom of movement is determined by the aligned first and second contact bodies. The base portion may rotate about an axis defined by a center line through the first and the second contact body. The third pivoting mechanism having a third contact body and a third counter body is arranged to compensate the second degree of freedom. The third contact body is staggered with respect to the first and the second contact body. By virtue thereof, a rotation about the pivot axis defined by the first and the second contact body is eliminated. A pivoting mechanism assembly results having one degree of freedom including a pivot axis determined by the aligned running surfaces.

In an embodiment of the hair cutting device according to the invention, the hair cutting device comprises a stacked pair of assemblies of pivoting mechanisms. Each pivoting mechanism assembly has at least three pivoting mechanisms, which are arranged as described above to define one virtual pivot axis. The stacked assemblies together may define two perpendicularly oriented virtual pivot axes. The two axes provide two degrees of freedom to a connected working head. By virtue thereof, advantageously, the working head may be connected by a virtual ball joint defined by the two virtual axes.

In an embodiment of the hair cutting device according to the invention, the hair cutting device is a shaving device. In particular, the working head is a shaving head. The shaving device may be of any kind. The shaving device may be an electrical shaving device, a single-use shaving device, a blade shaver, a vibra-shaver etc.

Further preferred embodiments are defined in the subclaims.

### BRIEF DESCRIPTION OF THE DRAWINGS

The invention will be explained in more detail with reference to the appended drawings. The drawings show a practical embodiment according to the invention, which may not be interpreted as limiting the scope of the invention. Specific features may also be considered apart from the shown embodiment and may be taken into account in a broader context as a characterizing feature, not only for the shown embodiment but as a common feature for all embodiments falling within the scope of the appended claims, in which:

FIGS. 1A-1E show in a schematic view several embodiments of a pivoting mechanism for a hair cutting device according to the invention;

FIG. 2A shows in a schematic view a preferred embodiment of the pivoting mechanism for a hair cutting device according to the invention;

FIG. 2B shows in an exploded view the pivoting mechanism as shown in FIG. 2A;

FIG. 3A shows in a perspective view a hair cutting device as a shaving device according to the invention;

FIG. 3B shows a schematic side view of the hair cutting device as shown in FIG. 3A;

FIG. 4 shows, in a schematic perspective view, a hair cutting device having a single virtual pivot axis; and

FIG. 5 shows in a perspective view a hair cutting device having two virtual pivot axes.

### DETAILED DESCRIPTION OF EMBODIMENTS

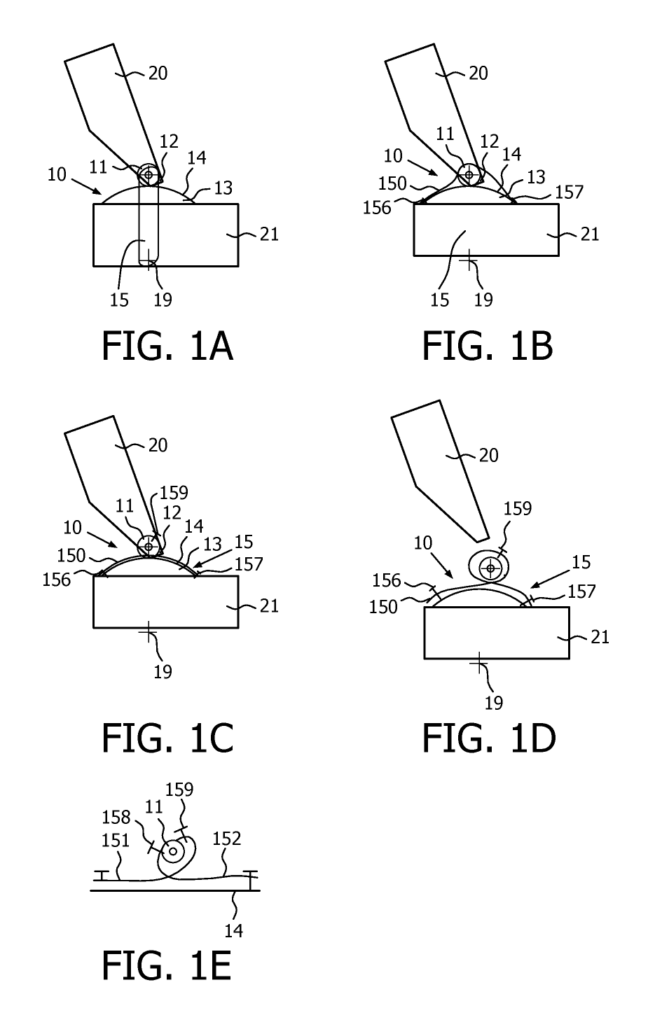

FIGS. 1A-1E show several embodiments of a pivoting mechanism 10 in between a base portion 20 and a working head 21 for integration into a hair cutting device. The base portion 20 of the hair cutting device may e.g. be a handle of a razor. The working head 21 may e.g. be a razor blade cartridge. The pivoting mechanism has a first pivoting part which is connected to the base portion 20 and a second pivoting part which is connected to the working head 21.

The pivoting mechanism 10 has a roller 11 which is rotatably connected to the base portion 20. The roller 11 has a roller surface 12. The roller surface may be circular. The roller 11 is movable about a counter body 13 which has a running surface 14. The counter body is arranged aside the roller. Preferably, the running surface is circular. The running surface may have a constant radius. The radius of the running surface determines a fixed pivot point 19 for the rolling movement of the roller 11. In FIG. 1A the fixed pivot point 19 is positioned close to a bottom surface of the working head 21. In FIGS. 1B-E, the fixed pivot point is positioned just below the bottom surface of the working head 21.

FIG. 1A shows a holding unit 15. The holding unit 15 is configured as a linking bar. The linking bar may keep the roller in contact with the running surface. The linking bar may be rigid or resilient. The linking bar may be elongated during a rolling movement of the roller 11. The linking bar has a first and a second connection point. The first connection point is connected to the roller, while the second connection point is connected to the working head. The second connection point of a rigid linking bar defines the pivot point of the roller for a rolling movement, while the running surface 14 of the counter body 13 defines the pivot point in the case of a resilient linking bar.

FIG. 1B shows an alternative embodiment of the pivoting mechanism 10. The configuration of the holding unit 150 of the shown pivoting mechanism 10 differs from the pivoting mechanism of FIG. 1A. In FIG. 1B, the holding unit 150 is longitudinal. The holding unit 150 has a first and a second end 156,157. Both ends of the holding unit 150 are fixed to the running surface 14 of the counter body 13. The holding unit is flexible and stretched along the roller 11. As a result, a pressing force is exerted on the roller to keep the roller surface 12 in contact with the running surface 14. The holding unit 150 may be of an elastomeric material. The pivot point 19 of the roller is determined by the running surface and is positioned just below the bottom surface of the working head 21.

FIG. 1C shows in a schematic view a preferred embodiment of the holding unit 150 of the pivoting mechanism 10 of the hair cutting device 1. FIG. 1D further elucidates the configuration by means of an exploded view. The holding unit 150 comprises a single wire. The wire extends along the running surface 14 of the counter body 13. The wire is fixed at both ends of the running surface. The roller 11 is movable in between both ends of the wire. The wire has an intermediate partition which is wound around the roller surface 12. During a movement of the roller 11, at one side the intermediate partition is wound up around the roller surface 12 and at the opposite side the intermediate partition is unwound. To prevent a slipping movement of the roller, the intermediate partition includes a fixation point 159. The wire is connected to the roller 11 at the fixation point. By virtue thereof, a slipping movement of the roller is prevented in both rolling directions.

FIG. 1E shows a further embodiment of the holding unit 150 of the pivoting mechanism 10. In comparison with FIG. 1D, the holding unit 150 in FIG. 1E is subdivided into two connecting components 151,152. Both connecting components are wires. The wires are both fixed at one end to the running surface. The first wire is connected to the running surface at an initial position of the roller, while the second wire is connected to the running surface at an end position of the roller. At the other end, both wires are connected to the roller surface 12. The roller surface may have a width, wherein the first wire is connected to a first side of the roller surface and the second wire is connected to an opposite second side of the roller surface.

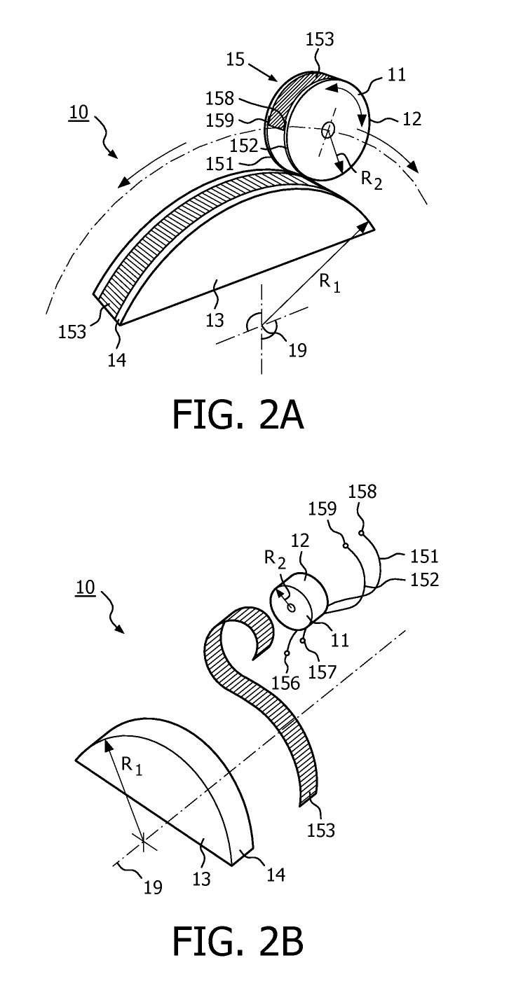

FIG. 2A shows in a schematic view a further embodiment of the pivoting mechanism 10 according to the invention. The pivoting mechanism comprises a roller 11 including a roller surface 12 and a counter body 13 including a convex running surface 14. Both surfaces have a constant radius R1, R2, which results in a fixed virtual pivot point 19.

FIG. 2B shows the pivoting mechanism as shown in FIG. 2A in an exploded view. A resilient holding unit is provided, which holding unit comprises two wires as connecting components 151, 152 and a spring leaf 153. The wires 151, 152 and spring leaf 153 are at one end 158,159 connected to the roller 11. The wires 151, 152 are arranged in parallel and fixed at the other end to one end of the running surface 14. The wires guide the roller along the running surface and prevent slip in a direction away from the wire fixation to the running surface. The spring leaf 153 is connected at the opposite end of the running surface 14. The spring leaf 153 is elongated and has a constant cross section. The spring leaf 153 prevents slip of the roller in one direction, while the wires prevent slip of the roller in the opposite direction. The spring leaf 153 extends from an initial position along the running surface to the roller surface. An end part of the spring leaf may be wound around the roller surface. During use of the hair cutting device, the spring leaf 153 returns the roller to the initial position when forces acting on the working head decrease.

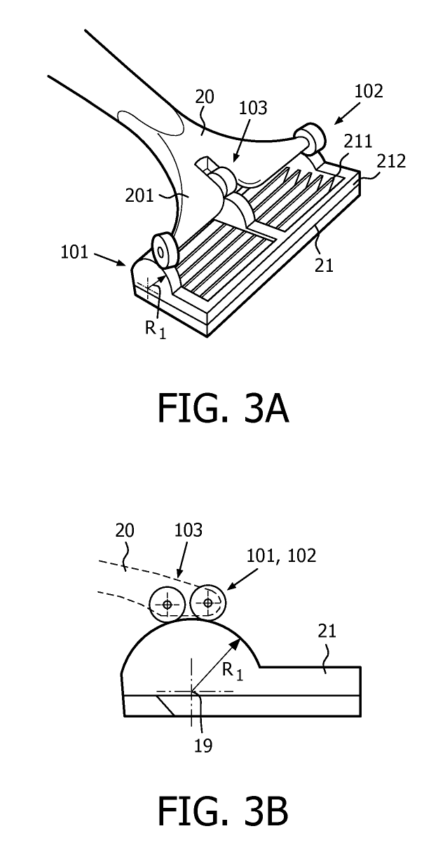

FIG. 3A shows in a perspective view a hair cutting device according to the invention. The hair cutting device has a base portion 20 and a working head 21. The base portion comprises a handle including a grip for hand-holding the device and a fork 201 at a distal end. The working head 21 comprises a blade cartridge. Several blades 211 are captured in a blade housing 212. The working head 21 is connected to the base portion 20 by a first, a second and a third pivoting mechanism 101, 102, 103. The pivoting mechanisms have a configuration as shown in FIG. 2A and 2B. The working head 21 has an initial position with respect to the base portion 20. During use, the working head 21 may be subjected to a resistance, which moves the working head with respect to the base portion. The three pivoting mechanisms are provided to obtain a proper movement of the working head 21. In particular, a pivoting movement may be achieved around a virtual axis 19 situated close to a bottom surface of the working head. The movement of the working head 21 is defined by the pivoting mechanisms 101, 102, 103.

As further shown in FIG. 3B, the first and the second pivoting mechanism 101, 102 are aligned with each other. The rollers and counter bodies of the first and the second pivoting mechanisms 101, 102 are aligned. The third pivoting mechanism 103 has a third counter body which is also aligned with the first and the second counter body. All running surfaces have a constant radius R1. A fixed virtual pivot axis is defined by the centreline of the aligned running surfaces. The first and the second pivoting mechanism 101, 102 together leave two degrees of freedom to the working head with respect to the base portion. A first degree of freedom is defined by the virtual pivot axis, and a second degree of freedom is defined by a centreline through the aligned rollers of the first and the second pivoting mechanism 101, 102. A third roller of the third pivoting mechanism disables the second degree of freedom. As shown, the third roller of the third pivoting mechanism 103 is staggered with respect to the first and the second roller of the first and the second pivoting mechanism 101,102. As a result, a pure rotation of the working head around the centreline of the first and the second roller is eliminated, which only leaves a pure rolling movement of the working head 21.

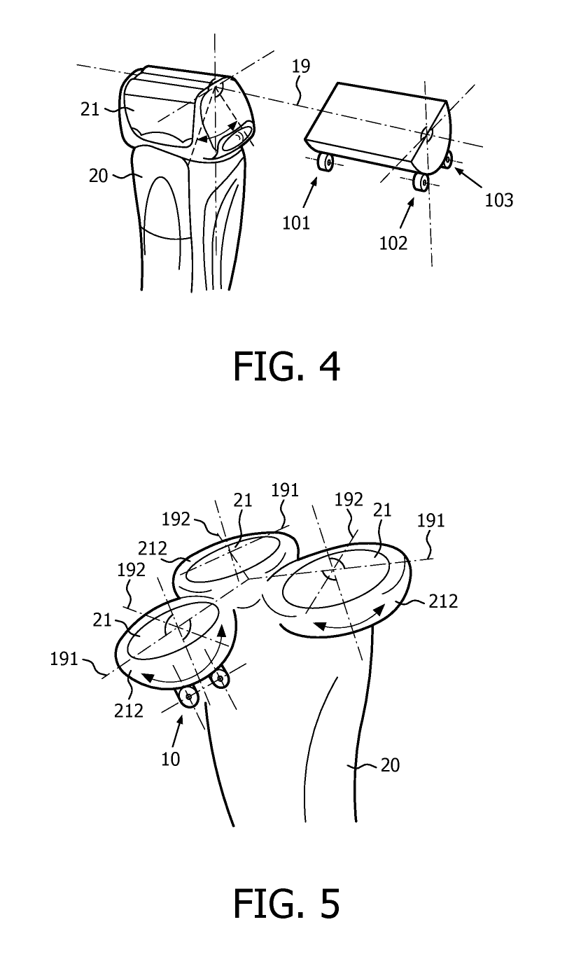

FIG. 4 shows an embodiment of an electric shaving device. The shaving device has a working head 21 including driven cutters in a cutter housing. Further, the working head has a reservoir for collecting shaved hairs. The shaving device has a base portion 20 including an interface for operating the shaving device and a grip. The working head is pivotably connected to a base portion to get improved skin contour following properties. Four pivoting mechanisms 101, 102, 103 (fourth not shown) are provided to connect the cutter housing to the base portion. The pivoting mechanisms are configured like the shown pivoting mechanisms in FIG. 2A and 2B. The pivoting mechanisms are arranged in two pairs of aligned mechanisms, which results in a single degree of freedom arrangement. The pivoting mechanisms are spatially positioned in four corners of the working head in cross section for receiving the voluminous working head. As a result, the shaving device may be provided with a rigid working head suspension. Advantageously, the suspension is less susceptible to friction and hysteresis.

FIG. 5 shows an alternative embodiment of an electric shaving device. The shaving device has a working head including driven cutters in three side-by-side arranged cutter housings. Each cutter housing may be pivotable about two virtual pivot axes 191, 192. Both virtual pivot axes may be positioned at an outer surface of the cutter housing, which corresponds with a skin level. A first virtual pivot axis may be achieved by an assembly of pivot mechanisms as shown in FIG. 4, while a second virtual pivot axis may be arranged by stacking a second assembly of pivot mechanisms up to the first assembly. Two stacked assemblies may provide the desired two virtual pivot axes, which act as a ball joint. The assemblies of pivoting mechanisms may have appropriate running surfaces to obtain virtual pivoting axes in a common plane.

Thus, according to the invention a hair cutting device is provided including an improved suspension of a working head relative to a base portion. In particular, a more comfortable hair cutting device is provided having improved skin contour following properties.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language, not excluding other elements or steps). Any reference signs in the claims should not be construed as limiting the scope of the claims or the invention. The mere fact that certain measures are recited in mutually different dependent claims does not indicate that a combination of these measures cannot be used to advantage.

Although this invention has been shown and described with respect to detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. For example, the shown spring leaf of the holding unit may have a decreasing cross section in a length direction. In another variant, running surfaces may have a non-constant radius. In an embodiment of a hair cutting device having an assembly of pivoting mechanisms, a common centrally located spring may be provided to obtain a spring-loaded assembly. The common spring may be located external to a pivoting mechanism. One pivoting mechanism provided with a spring may be sufficient to achieve also a spring load on other pivoting mechanisms of the hair cutting device. As a result, it may not be necessary to provide an individual spring for each individual pivoting mechanism. Therefore, it is intended that the invention not be limited to the particular embodiments disclosed in the above detailed description, but that the invention will include all embodiments falling within the scope of the appended claims.

1. Hair cutting device comprising:
a base portion (20) including a grip configured to be gripped by a user;
a working head (21) configured to hold at least one cutter; and
a pivoting mechanism (10) configured to pivotally connect the base portion (20) to the working head (21) and configured to provide an outer virtual pivot axis (19), wherein said pivoting mechanism comprises:
a contact body (11) having an outer contact surface (12), wherein said contact body is connected to the base portion (20);
a counter body (13) having an outer running surface (14), wherein the counter body is connected to the working head (21); and
a holding unit (15) for guiding the contact body (11) from an initial position over a stroke along the running surface of the counter body (13), wherein the holding unit (15) is spring-loaded for returning the contact body (11) to the initial position along the running surface (14), wherein the holding unit (15) comprises at least one elongated connecting component (151) which extends at least partially tangentially along the running surface (14).

2. Hair cutting device according to claim 1, wherein the contact body (11) is a roller having a circumferential roller surface as a contact surface.

3. Hair cutting device according to claim 1 or 2, wherein the contact body (11) has a cylindrical contact surface with a constant radius (R2) and wherein the counter body (13) has a convex running surface with a constant radius (R1).

4. Hair cutting device according to any of the preceding claims, wherein the running surface (14) of the counter body (13) comprises at least two different running surface sections.

5. Hair cutting device according to any one of the preceding claims, wherein at least one of the running surface (14) and the contact surface (12) comprises a groove which extends in a length direction.

6. Hair cutting device according to any one of the preceding claims, wherein the holding unit (15) is elongated having a first end and a second end, wherein said first end is connected to a first position on the running surface and said second end is connected to a second position on the running surface.

7. Hair cutting device according to any one of the claims 2 to 5, wherein the connecting component (151) is at least partially wound on the roller surface of the roller.

8. Hair cutting device according to any one of the preceding claims, wherein the holding unit (15) has a fixation point (159) at an intermediate partition thereof, wherein the holding unit (15) is fixed at the fixation point (159) to the contact body (11).

9. Hair cutting device according to any one of the preceding claims, wherein the holding unit (15) comprises a first and a second connecting component (151,152), wherein the connecting components (151,152) are a pair of wires.

10. Hair cutting device according to any one of the preceding claims, wherein the holding unit (15) and the contact body (11) are formed in one piece.

11. Hair cutting device according to any one of the claims 8 to 10, wherein one of the connecting components (151,152) is resilient to return the contact body (11) to an initial position.

12. Hair cutting device according to any one of the claims 8 to 10, wherein the holding unit (15) comprises a spring leaf (153) to return the contact body (11) to an initial position.

13. Hair cutting device according to claim 12, wherein the spring leaf (153) has a decreasing cross section in a length direction.

14. Hair cutting device according to any one of the preceding claims, wherein the hair cutting device comprises an assembly of at least three pivoting mechanisms comprising:
a first pivoting mechanism (101) having a first contact body and a first counter body;
a second pivoting mechanism (102) having a second contact body and a second counter body, wherein the first and the second contact body are aligned with each other;
a third pivoting mechanism (103) having a third contact body and a third counter body, wherein the third contact body is staggered with respect to the first and the second contact body, wherein the first, the second and the third counter body are connected to the working head (21) and aligned with each other for defining the virtual pivot axis (19).

15. Hair cutting device according to claim 14, comprising a stacked pair of assemblies of pivoting mechanisms, which assemblies each define one virtual pivot axis, wherein both virtual pivot axes (191,192) are substantially perpendicularly positioned to define a ball joint.
